(19) United States
(12) Patent Application Publication
(10) Pub. No.: US 2020/0326229 A1
(43) Pub. Date: Oct. 15, 2020

(54) TEST BOX

(71) Applicants: Hefei BOE Vision-Electronic Technology Co., Ltd., Hefei, Anhui (CN); BOE Technology Group Co., Ltd., Beijing (CN)

(72) Inventor: Qianqian HU, Beijing (CN)

(21) Appl. No.: 16/620,623

(22) PCT Filed: Mar. 25, 2019
(86) PCT No.: PCT/CN2019/079597

§ 371 Date: Dec. 9, 2019

(30) Foreign Application Priority Data
Mar. 26, 2018 (CN) 201820412793.1

(51) Int. Cl. G01H 17/00; G01M 13/00; H04R 1/02; G10K 11/162; H04R 1/10

(52) U.S. Cl. CPC G01H 17/00; G01M 13/00; H04R 1/10; G10K 11/162; H04R 1/02

(57) ABSTRACT

A test box, comprising: a test box body in which chamber used for placing a machine is formed; a microphone provided on the test box body; and a rotating component rotatably connected to the test box by means of a connecting assembly. The rotating component is provided with a through hole, and one end of the microphone passes through the through hole and extends into the chamber of the test box body. In the test box, the microphone is rotatably provided on the test box body, and one end of the microphone extends into the inner chamber of the test box body. By adjusting the position of the microphone, the position of the component in the tested machine that produces noise is determined, so that the component in the machine that produces noise is determined, thereby implementing the detection of a machine in which a small component produces noise. Moreover, the test box features a simple structure and low costs, and reduces costs while improving the detection efficiency.

The disclosure is a US National Stage of International Application No. PCT/CN2019/079597, filed Mar. 25, 2019, which claims the priority from Chinese Patent Publication No. 201820412793.1, filed with the Chinese Patent Office on Mar. 26, 2018 and entitled “a Test Box”, the disclosure of which is incorporated by reference herein in its entirety.

### FIELD

The present application relates to the field of noise detection technologies, and particularly to a test box.

### BACKGROUND

In the complete machine manufacturing industry, the case that the machine has the noise may occur when the machine is tested, so there is a need to determine noise source of electronic components for each machine. However the noise source of the electronic components required to be found is often a small part.

### SUMMARY

An embodiment of the disclosure provides a test box. The test box includes: a test box body in which a chamber for placing a machine is formed; a microphone arranged on the test box body; a rotating means connected rotationally with the test box body, where the rotating means is provided with a through hole thereon, and an end of the microphone passes through the through hole and extends into the chamber of the test box body.

Optionally, the microphone is expandable and movable with respect to the through hole.

Optionally, the test box further includes a connecting component through which the rotating means is connected rotationally with the test box body; the connecting component comprises a jaw component for clamping the rotating means, where the jaw component comprises a jaw means arranged outside the rotating means and a lock nut for matching with the jaw means; when the rotating means rotates, the lock nut is in a to-be-tighten state in which there is a gap between the jaw means and the rotating means; when the rotating means is located, the lock nut is tighten, and a jaw of the jaw means clamps the rotating means.

Optionally, the rotating means is a spherical means.

Optionally, the microphone, test box body and connecting component are all made of the insulating materials.

Optionally, the test box body comprises a box enclosure and a base which are connected detachably.

Optionally, at least one layer of sound absorption structure is arranged on the internal surface of the box enclosure.

Optionally, the sound absorption structure includes the sound absorption cotton.

Optionally, at least one layer of sound absorption structure is arranged on the lateral surface of the base for placing the machine.

Optionally, the test box body is provided with a lead hole for leading out a power line and a signal line of the machine.

Optionally, the test box further includes an earphone component and a flexible tube, where the earphone component is connected with the end of the microphone back on to the test box body via the flexible tube.

Optionally, the test box body is provided with at least one opening, and a squint window is arranged at each opening.

Optionally, the squint window is a double-layer window structure.

Optionally, the squint window is made from the acrylic materials.

### BRIEF DESCRIPTION OF THE DRAWINGS

FIG. 1 is a structural schematic diagram of a test box provided by an embodiment of the disclosure.

FIG. 2 is a structural schematic diagram of a base in the test box provided by an embodiment of the disclosure.

FIG. 3 is a structural schematic diagram of a box enclosure in the test box provided by an embodiment of the disclosure.

### DETAILED DESCRIPTION

The technical solutions in the embodiments of the present application will be described clearly and completely below in combination with the accompanying drawings in the embodiments of the present application. Obviously the described embodiments are only a part of the embodiments of the present application but not all the embodiments. Based upon the embodiments of the present application, all of other embodiments obtained by those ordinary skilled in the art without creative work pertain to the protection scope of the present application.

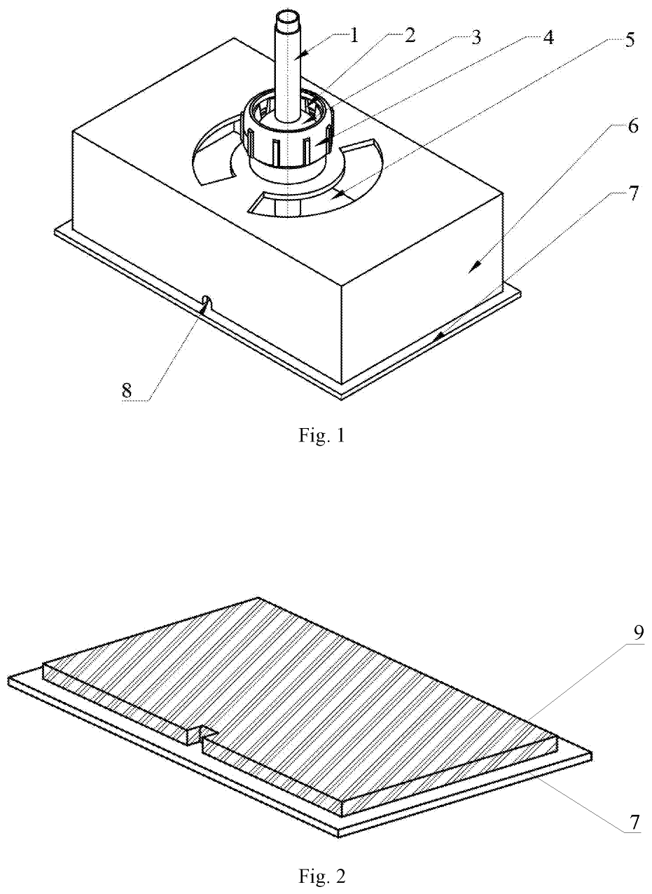

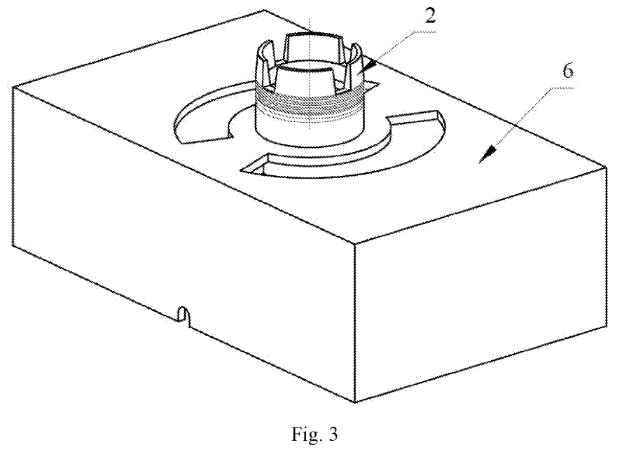

Please referring to FIGS. 1 to 3, a test box provided by an embodiment of the present application includes: a test box body in which a chamber for placing a machine is formed; a microphone 1 arranged on the test box body; a rotating means 3 connected rotationally with the test box body, where the rotating means 3 is provided with a through hole thereon, and one end of the microphone 1 passes through the through hole and extends into the chamber of the test box body.

In the above-mentioned test box, the rotating means 3 is arranged rotationally on the test box body. One end of the microphone 1 passes through the through hole on the rotating means 3, extends into the chamber of the test box body, and detects the noise emitted by an object under test. In the detection process, the microphone 1 rotates with the rotating means 3, implementing the position adjustment of the part of the microphone 1 extending into the chamber. The means emitting the noise in the machine is determined by locating the means of the machine emitting the noise through the microphone 1, to thereby implement the detection of the machine in which the noise is emitted by the small means. The test box has the simple structure and lower cost, increasing the detection efficiency while reducing the cost.

Specifically, the microphone 1 is expandable and movable with respect to the through hole on the rotating means 3. Thus in the noise detection process, the microphone 1 may move in the direction close to the test box body or in the direction far from the test box body via the through hole, to adjust the length of the microphone 1 extending into the chamber of the test box body, implement the more precise position adjustment of the part of the microphone 1 extending into the chamber, and thereby increase the positioning precision of the part of the machine emitting the noise.

Specifically, the test box provided by the embodiment of the present application further includes a connecting component through which the rotating means 3 is connected rotationally with the test box body. The connecting component includes a jaw component for clamping the rotating means 3, where the jaw component includes a jaw means 2 arranged outside the rotating means 3 and a lock nut 4 for spirally matching with the jaw means 2. When the rotating means 3 rotates, the lock nut 4 is in the to-be-tighten state in which there is a gap between the jaw means 2 and the rotating means 3. When the rotating means 3 is located, the lock nut 4 is tighten, and the jaw of the jaw means 2 clamps the rotating means 3.

In the above-mentioned jaw component, the jaw means 2 is arranged outside the rotating means 3. When the position of the microphone 1 is adjusted, the lock nut 4 is in the to-be-tighten state. At this time, the jaw means 2 is in an initial state, and the rotating means 3 rotates to adjust the position of the microphone 1. When the microphone 1 is adjusted to the part emitting the noise, the lock nut 4 is tighten. At this time, the jaw means 2 gathers towards the direction of the rotating means 3, and the rotating means 3 is clamped. At this time, the rotating means 3 is fixed and cannot be adjusted, implementing the fixed adjustment of the deflection angle of the microphone 1 within the chamber. The jaw component has the simple structure and is easy to operate.

Specifically, the rotating means 3 is a spherical means.

The spherical means is used as the above-mentioned rotating means 3. When the test box is assembled, it is uneasy to assemble the rotating means 3 by mistake, and the spherical means may rotate about its center by any angle, facilitating the position adjustment of the microphone 1.

Specifically, the microphone 1, test box body and connecting component are all made of insulating materials.

When the noise source is determined for the machine, all the operations are the hot-line work. The power panel of the detached machine has the high-voltage zone of which the voltage is at least 220V, and there is the safety hazard of electric shock. The above-mentioned microphone 1, test box body and connecting component are all the insulators, which can insulate the high-voltage zone and increase the detection security.

Specifically, the test box body includes a box enclosure 6 and a base 7 which are connected detachably.

The above-mentioned test box body uses the detachable box enclosure 6 and base 7, facilitating the detection of the machine.

Specifically, at least one layer of sound absorption structure is arranged on the internal surface of the box enclosure 6.

Specifically, the sound absorption structure includes the sound absorption cotton.

The absorption mechanism is arranged on the internal surface of the above-mentioned box enclosure 6, which prevents the interference of the external noise effectively when detecting the machine, and increases the accuracy of the machine detection.

Specifically, at least one layer of sound absorption structure is arranged on the lateral surface of the base 7 for placing the machine, and the sound absorption structure can include the sound absorption cotton 9.

The above-mentioned base 7 is provided with the sound absorption cotton 9, which prevents the interference of the external noise effectively when detecting the machine, and increases the accuracy of the machine detection.

Specifically, the test box body is provided with a lead hole 8 for leading out a power line and a signal line of the machine.

Specifically, the test box provided by the present application further includes an earphone component and a flexible tube, where the earphone component is connected with the end of the microphone 1 back on to the test box body via the flexible tube.

Specifically, the earphone component includes a megaphone means.

The end of the above-mentioned microphone 1 back on to the test box body is connected to the earphone component via the flexible tube, facilitating the positioning of the part emitting the noise by the inspector. Since the earphone component includes the megaphone means, the detected noise can be amplified effectively. And the flexible tube has the good sound transmission effect, which can increase the detection accuracy.

Specifically, the test box body is provided with at least one opening, and a squint window 5 is arranged at each opening.

Specifically, the squint window 5 is a double-layer window structure.

Specifically, the squint window 5 is made from the acrylic materials.

The above-mentioned test box body is provided with the squint window 5, facilitating the observing of the machine situation and the position of the microphone 1 by the inspector, and the squint window 5 is made from the acrylic materials, avoiding the occurrence of the electric leakage situation in the test process effectively and ensuring the safety of the inspector.

Evidently those skilled in the art can make various modifications and variations to the embodiments of the present application without departing from the spirit and scope of the present application. Thus the present application is also intended to encompass these modifications and variations therein as long as these modifications and variations to the present application come into the scope of the claims of the present application and their equivalents.

1. A test box, comprising:
a test box body in which a chamber for placing a machine is formed;
a microphone arranged on the test box body; and
a rotating means connected rotationally with the test box body, wherein the rotating means is provided with a through hole thereon, and an end of the microphone passes through the through hole and extends into the chamber of the test box body.

2. The test box according to claim 1, wherein the microphone is expandable and movable with respect to the through hole.

3. The test box according to claim 1, further comprising:
a connecting component, comprising a jaw component for clamping the rotating means, wherein the jaw component comprises a jaw means arranged outside the rotating means and a lock nut for matching with the jaw means;
wherein the rotating means is connected rotationally with the test box body via the connecting component;
when the rotating means rotates, the lock nut is in a to-be-tighten state in which there is a gap between the jaw means and the rotating means; and
when the rotating means is located, the lock nut is tighten, and a jaw of the jaw means clamps the rotating means.

4. The test box according to claim 3, wherein the rotating means is a spherical means.

5. The test box according to claim 3, wherein the microphone, the test box body and the connecting component are all made of insulating materials.

6. The test box according to claim 1, wherein the test box body comprises a box enclosure and a base which are connected detachably.

7. The test box according to claim 6, wherein at least one layer of sound absorption structure is arranged on an internal surface of the box enclosure.

8. The test box according to claim 7, wherein the sound absorption structure comprises sound absorption cotton.

9. The test box according to claim 6, wherein at least one layer of sound absorption structure is arranged on a lateral surface of the base for placing the machine.

10. The test box according to claim 1, wherein the test box body is provided with a lead hole for leading out a power line and a signal line of the machine.

11. The test box according to claim 1, further comprising an earphone component and a flexible tube, wherein the earphone component is connected with an end of the microphone back on to the test box body via the flexible tube.

12. The test box according to claim 1, wherein the test box body is provided with at least one opening, and a squint window is arranged at each opening.

13. The test box according to claim 12, wherein the squint window is a double-layer window structure.

14. The test box according to claim 12, wherein the squint window is made from acrylic materials.
